(19) United States
(12) Patent Application Publication
(10) Pub. No.: US 2016/0282493 A1
(43) Pub. Date: Sep. 29, 2016

(54) Underwater Location

(71) Applicant: Seismic Stuff (UK) Ltd., Kent (GB)

(72) Inventor: Craig Jonathan Sendall Douglas, Kent (GB)

(21) Appl. No.: 15/079,468

(22) Filed: Mar. 24, 2016

(30) Foreign Application Priority Data
Mar. 24, 2015 (GB) 1504968.7

(51) Int. Cl. G01V 1/38; G01V 1/137

(52) U.S. Cl. CPC G01V 1/3835; G01V 1/137

(57) ABSTRACT

A seismic array has buoys 4 supporting platforms 10 and airguns 20 for use on a water surface 8. The platforms 10 comprise one or more cameras 16,18,42,44 which are used to image the buoy and which may also be used to image the airgun 10 or other platforms. Together with other information, this may more accurately locate the platforms 10 and airguns 20 even as these move about in water to improve the accuracy of seismic measurements.

### FIELD OF INVENTION

The invention relates to a system used in underwater, in particular subsea instrumentation, and a corresponding method.

### BACKGROUND TO THE INVENTION

Seismic data analysis is a technique typically used for determining a profile of a geophysical structure. Such analysis often is carried out under a sea bed.

In order to carry out such an analysis, “guns” are used to generate explosions and the resulting sound signal is picked up by hydrophones. The guns are located underwater and generate a bubble.

In general, arrays of guns are use in combination with arrays of hydrophones. The use of an array of guns fired together allows the generation of a directional sound wave travelling through water. The resulting signal picked up by the array of hydrophones may be used to generate a profile of a geophysical structure.

In practice, arrays of hydrophones and guns are towed by a boat. The boat tows a plurality of cables, each of which has a number of buoys. A hydrophone is suspended under each buoy and a gun suspended under each hydrophone.

In order to carry out accurate data analysis, it is necessary to know the exact position of each gun and each hydrophone when the array is fired. This may be done using a gps tracker in each buoy.

However, the reality is that the exact location of each hydrophone and each gun differs considerably from the location of the buoy, as a result of waves, currents and the motion of the boat towing the array through the water. This means that the location of each hydrophone and gun is accurate only to the order of a couple of meters. This is not accurate enough for precise measurements.

Previous attempts to measure the positions of the various elements of the array have used acoustic techniques.

### SUMMARY OF THE INVENTION

According to the invention, there is provided a seismic array, comprising:
a plurality of buoys for floating on water;
a plurality of platforms, each platform being attached to a respective buoy by a line; and
a plurality of airguns, each being attached to a respective platform by a line;
characterised by further comprising a camera on the platform, the camera being arranged to locate the buoy or the airgun with respect to the platform.

By locating the relative positions of buoys, airguns and/or platforms with cameras, the accuracy of the location can be significantly improved even in the event of waves, currents or artefacts caused by towing the seismic array. This in turn makes it possible to provide significantly more accurate seismic data.

The seismic array may further comprise a processor, the processor being arranged to calculate the location of each of the airguns. A single processor may be provided centrally or a processor may be provided on each platform.

Each platform may comprise a sensor for determining the roll angle and tilt angle of the platform. This information is to be combined with the image taken by the camera to locate the position of the buoy or airgun with respect to the platform.

Each platform may comprise a first camera on the upper side of the platform for capturing an image of the respective buoy in its field of view and a second camera on the lower side of the platform for capturing an image of the airgun in its field of view.

Each platform may further comprise at least one third camera mounted on the platform facing sideways for capturing an image of at least one other platform in its field of view.

The platforms may support hydrophones.

There may be further provided at least one high contrast target on the buoys, platforms and/or airguns. The use of a high contrast target can ease image analysis since it may make it easier to locate the buoy, platform or airgun more exactly in an image.

There may be at least two high contrast targets on at least one of the buoys, airguns and platforms, so that the apparent distance between the high contrast targets in an image can be used to estimate the distance to the high contrast targets.

The target may be illuminated, either permanently or synchronised with the camera to easer object finding.

In another aspect, there is provided a method of calculating positions of elements of a seismic array comprising a plurality of buoys for floating on water, a plurality of platforms, each platform being attached to a respective buoy by a line; and a plurality of airguns, each being attached to a respective platform by a line, the method comprising:

capturing an image of the buoy with a camera mounted on a platform;

measuring the tilt and the roll of the platform;

identifying the position of the buoy in the image; and

calculating the relative position of the platform from the identified position of the buoy in the image, the measured tilt, and the measured roll.

The method may further comprise:

capturing an image of the airgun with a camera mounted on a platform;

identifying the position of the airgun in the image; and

calculating the relative position of the airgun from the identified position of the airgun in the image, the measured tilt, the measured roll, and the calculated relative position of the platform.

The method may further comprise:

measuring the absolute position of the buoy with a GPS system, and

calculating the absolute position of the platform and the airgun from the absolute position of the buoy, the relative position of the platform and the relative position of the airgun.

The method may include capturing images of respective neighbouring platforms for each of a plurality of platforms in a network, each attached to a respective buoy, and identifying the position of the neighbouring platform in the image;

calculating vectors representing the distance and direction to each of the respective neighbouring platforms from the identified positions of the neighbouring platforms, the tilt, and the roll; and

calculating the relative location of the each platform in the network using the vectors calculated from the images captured by the plurality of platforms.

In a particular embodiment, the method may include calculating an ellipse indicating the relative location of each platform with a predetermined confidence level from the vectors.

The step of identifying the position of an object, the object being a platform, buoy, or airgun, may be carried out by:

calculating the correlation of the image with a reference image of the object in a known position for a plurality of offsets of the reference image;

determining the offset with the highest correlation; and

outputting the identified position of the object in the image from the determined offset.

The method may further include calculating the distance to an object, the object being a platform, buoy, or airgun, by:

identifying two locations on the object in the image of the object, the two locations being a known distance apart;

determining the distance in the image between the two locations; and

calculating the distance to the object from the distance in the image and the known distance between the locations.

### BRIEF DESCRIPTION OF THE DRAWINGS

An example of the invention will now be described with reference to the accompanying diagrams, in which:

FIG. 1 shows a top view first embodiment of a seismic array according to the invention;

FIG. 2 shows a side view of a single buoy, platform and airgun of the seismic array of FIG. 1;

FIG. 3 shows a high contrast target;

FIG. 4 shows a detail top view of a platform of the arrangement of FIGS. 1 and 2;

FIG. 5 illustrates the calculation of a confidence ellipse; and

FIG. 6 illustrates pulse data captured using a camera in an embodiment of the invention.

The drawings are schematic and not to scale.

### DETAILED DESCRIPTION

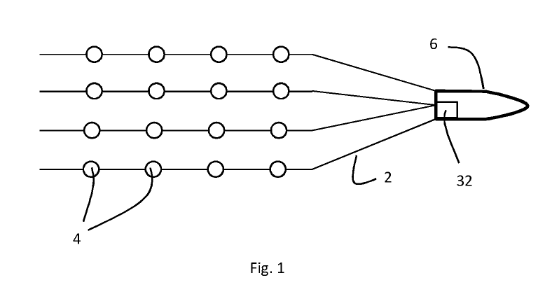

Referring to FIG. 1, a view from above, a seismic array comprises a plurality of cables 2, each cable having a plurality of buoys 4 (also known as floats) arranged at intervals along the cable. The cables are attached to a ship 6 and extend backwards from the ship.

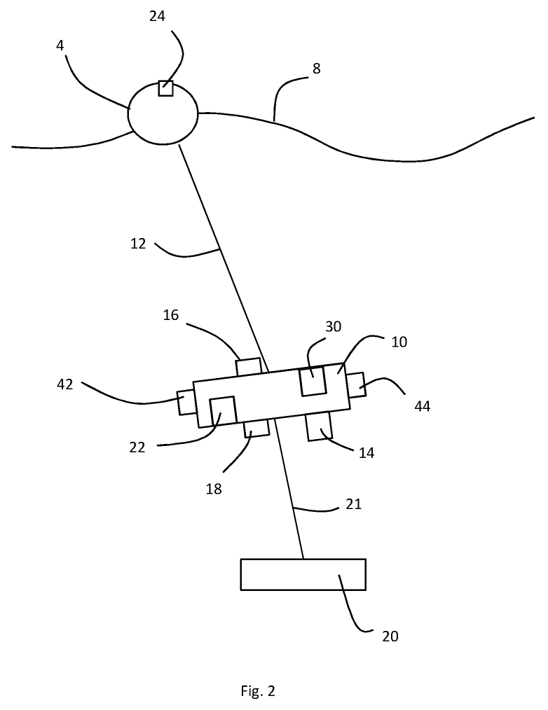

Referring to side view, FIG. 2, the buoys 4 float on the surface of the water 8. A platform 10 is suspended below each buoy 4 by a line 12. A hydrophone 14, an upper camera 16 and a lower camera 18 are mounted on each platform.

An air gun 20 is suspended below each platform 10, again by a line 21.

The upper camera 16 is mounted on the platform 10 such that the buoy 4 is within the field of view. As the platform 10 moves with respect to the buoy as a results of waves, currents, or the movement of the ship 6 and the buoys suspended on the cable 2, the upper camera can accordingly track the relative position of the buoy 4 and platform 10.

As for the lower camera 18, this is mounted below the platform 10 with the air gun 20 in its field of view to track the relative position of the platform 10 and the air gun 20.

An orientation sensor 22 is provided on the platform 10. A GPS unit 24 is provided on the buoy 4. The orientation sensor 22 is capable of measuring both pitch and roll, for example using a three-axis accelerometer.

A processor 30 is provided to carry out calculations and in the embodiment this is provided on the platform 10. This reduces the amount of data that needs to be uploaded to processor 32 on the ship 6. However, in alternative embodiments, the processor 30 is omitted and all processing carried out in processor 32.

In use, the signals from the upper camera 16, lower camera 18, tilt sensor 22 and GPS unit 24 are brought to processor 30 and used to calculate the relative position of the buoy 4, platform 10 and air gun 20. See FIG. 2. Note that the tilt angle is necessary so that the orientation of the camera is known.

Note that even when using an inexpensive camera as upper or lower camera 16, 18 the accuracy of the method can be quite high. Consider for example the case of the upper camera with a line 12 of 6m long. A relatively inexpensive camera can produce jpg images at VGA resolution, i.e. 640×480 pixels. If the camera has a field of view of 45° from the centre line, then the field of view is 6 m wide and one pixel corresponds to a movement of 1 cm in relative position of the buoy and platform. It is possible to determine the position to an accuracy of a few pixels, so about 5 cm. This is very much better than conventional methods which are only accurate to the order of 1 m.

A further benefit of using a relatively low resolution VGA camera is that the image size is relatively small, with compression only 50 kbytes. Thus, the use of such a camera can reduce the need for rapid data transmission.

In order to determine the position of the buoy 4 in the field of view of the upper camera 1, it is necessary to locate the buoy 4 in the image taken by the upper camera. In the embodiment, this is carried out by image correlation with a reference image. The reference image is an image of the buoy taken with all components in a known position. The maximum correlation of the image with the reference image for a variety of possible displacements is determined and the displacement corresponding to the maximum correlation is taken as the displacement of the buoy in the image from its position in the reference image.

A similar approach is taken for the lower camera. A reference image of the air gun is taken with the components all in a known position and the displacement of an image that gives the maximum correlation with the reference image is determined to give the displacement of the air gun from its position in the reference image.

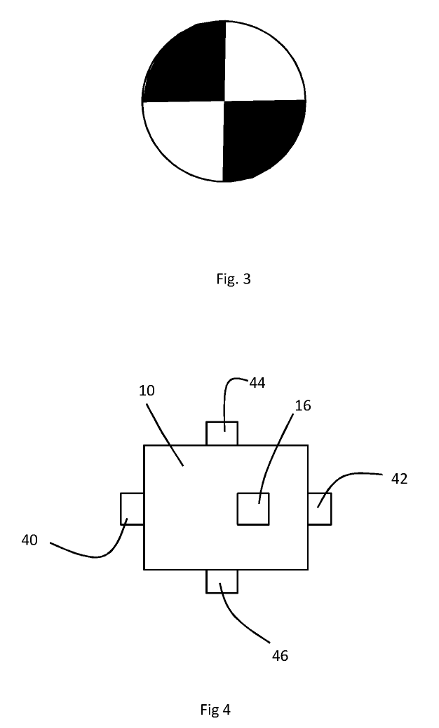

To enhance the accuracy of the location, a high contrast target such as those illustrated in FIG. 3 is provided on the buoy and/or hydrophone.

A further enhancement is to provide two high contrast targets on the buoy. In this case, it is possible to determine the distance between the buoy 4 and the platform 10 by measuring the distance between the centres of the high contrast targets in the image captured by the upper camera.

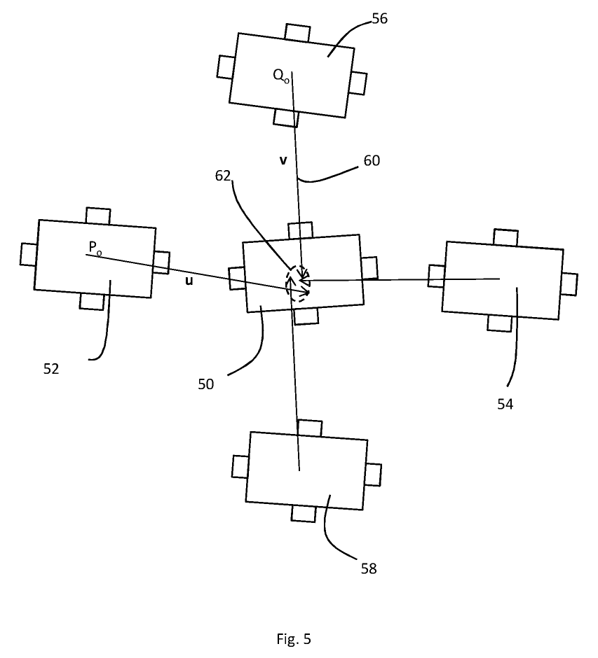

In a development, illustrated in FIG. 4, side cameras 40, 42, 44, 46 are mounted on each platform of an array. These are used to locate also the neighbouring platforms to each platform. This allows the position of each platform to be more accurately determined from one another.

Referring to FIG. 5, a view from the top the position of each platform 50 is determined by a number of vectors 60 indicating the relative position of each platform 50 from neighbouring platforms 52, 54, 56, 58. The camera determines the direction to the neighbouring platform.

Note that each of these vectors may be an average of the vector determined from the camera on the neighbouring platform 52, 54, 56, 58 to the platform 50 and the vector determined by the respective camera on the platform 50 to the respective neighbouring platform.

These vectors should of course all lead to the same position but experimental errors will result in slight discrepancies in the position determined by each vector. Accordingly, there may be determined a probability ellipsoid 62 indicating a particular confidence limit, for example 95%. In this example, there is a 95% chance of the platform being located in the probability ellipse 62. The smaller the ellipse, the greater the precision of measurement of the position of the platform.

In more detail, the method works as follows. Consider a set of vectors from neighbouring platforms that each indicate the direction from the neighbouring platform. The distance to each neighbouring platform is not known.

For two specific vectors u and v from two neighbouring platforms P and Q (in the example of FIG. 5 these are platforms 52, 56 respectively) to the platform whose location is to be determined the vectors in general will define lines that do not intersect. For this pair, there is a unique pair of closest points which mark the closest approach of the two lines defined by the location of the respective neighbouring platform P and Q and the direction u or v. The midpoint of the line joining these two closest points is an estimate of the position of the platform.

Consider two lines starting from the camera on neighbouring platforms at Pₒ and Qₒ with respective direction vectors u and v obtained from the images taken by the cameras. The lines ares then defined by the sets of points Pₒ+s u and Qₒ+t v where s and t are each any real number. There are a number of ways of finding the line of minimal length joining these lines. The values of s and t corresponding to the points of closest approach will be referred to as s_{c} and t_{c}.

The vector w_{c} between the closest points has the unique property that it is perpendicular to both lines and hence we have w_{c}·u=0 and w_{c}·v=0, effectively a pair of simultaneous equations.

Taking w_{c}·=P(S_{c})−Q(t_{c})=wₒ+s_{c}u+t_{c}v with wₒ=Pₒ−Qₒ we have

(u·u)s_{c}−(u·v)t_{c}==−u wₒ

(v·u)s_{c}−(v·v)t_{c}==−v wₒ

which with the substitution a=(u·u), b=(u·v), c=(v·v) d=(u·wₒ) and
e=(v·wₒ) gives equations that can be solved to give

s_{c}=(be−cd)/(ac−b²) and

t_{c}=(ae−bd)/(ac−b²) where (ac−b²) is no zero.

These values directly give the locations of the closest points as (Pₒ+s_{c} u) and (Qₒ+t_{c} u) and hence the midpoint of these two points gives an estimate of the position of the platform in question.

This method is computationally efficient compared with methods involving calculus, for example.

In general, there will be more than two vectors indicating the position of each platform to be determined. Where there are N vectors there are N(N−1) pairs of vectors. Each of these pair of vectors leads to a midpoint as an estimate of the position of the platform.

In an embodiment, the set of midpoints for each of the N(N−1) pairs of vectors is obtained leading to a set of estimates of the position of the platform whose location is to be determined.

Then a 3D ellipsoid 62 is fitted to this set of points giving an indication of the confidence of the derived position. The method used may be that proposed in: http://www.sci.utah.edu/˜balling/FEtools/doc_files/LeastSquaresFitting.pdf

By using this technique on each platform, a grid of positions of the platforms can be built up. Accordingly, using these multiple cameras a more accurate measure of the relative position of each platform can be determined as a network, together with a measure of the accuracy of each location.

The relative position of each item in the network may be linked with elements of the network with known position, for example buoys with GPS, subsea nodes with acoustic positions known, or seabed objects. In this way, the absolute positions of the items of the network can be determined.

The pitch and roll are determined from the readings of the three-axis accelerometer.

A flash unit may be added to the cameras. This may be used in the case of low light to enhance contrast.

By finding the positions of the platforms and the guns the exact location of every component of the array may be found to an accuracy much better than simply taking the location of the buoy 4 and using GPS.

The cameras may have further uses.

For example, the cameras may be used to determine the exact moment of firing of each of the airguns 20. In this case, the lower camera 18 facing the airgun should be a video camera capable of high speed video. The bubble reaches maximum size at the moment that the airgun is generating maximum pressure. Analysis of high speed video of the airgun allows the determination of the exact moment the gun is fired.

The more accurate the location information and the timing information, the better the accuracy of the seismic survey.

In more detail, the reason the gun timing can be accurately measured is that the bubble surface is very white and therefore by illuminating the bubble with a constant light source the measured amount of backscattered light provides a signal representative of the size of the bubble and hence the pressure generated by the firing of the airgun.

The peak in brightness can accordingly be used to determine when the gun fired. To get the accuracy to levels required for the best results, the camera should operate at 1000 frames per second. The camera does not just capture the peak of the pressure determining the moment of firing but also the shape of the signal as a function of time represents the signature of the individual gun.

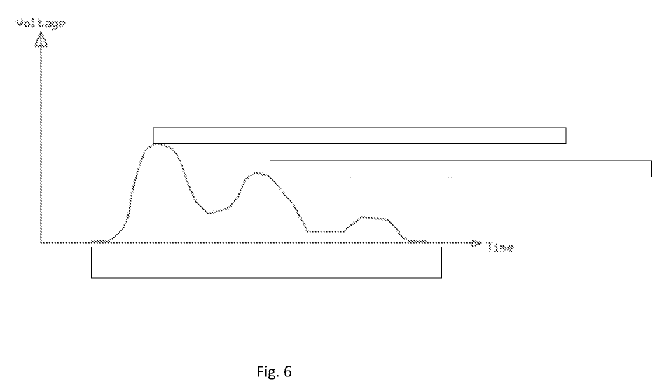

FIG. 6 illustrates an example signal of a voltage representing the detected light over time. The first peak indicates the moment of firing. Subsequent peaks are generated by bubble oscillation and can be ignored.

A further use for a rearwards facing camera on a rear platform is to find air leaks.

Aerated water is very white and causes a lot of scattering when illuminated. Airleaks are very problematic for surveys as they directly impact the performance of the near field hydrophones since aerated water becomes compressible and absorbs the acoustic energy trying to pass through it, muffling the sound of the gun firing. By detecting air leaks with the camera, such airleaks can be detected and dealt with.

1. A seismic array, comprising:
a plurality of buoys for floating on water;
a plurality of platforms, each platform being attached to a respective buoy by a line; and
a plurality of airguns, each being attached to a respective platform by a line;
characterised by further comprising a camera on the platform, the camera being arranged to locate the buoy or the airgun with respect to the platform.

2. A seismic array according to claim 1 further comprising a processor, the processor being arranged to calculate the location of each of the guns

3. A seismic array according to claim 1, wherein each platform comprises a sensor for determining the roll angle and tilt angle of the platform.

4. A seismic array according to claim 1, wherein each platform comprises a first camera on the upper side of the platform for capturing an image of the respective buoy in its field of view and a second camera on the lower side of the platform for capturing an image of the gun in its field of view.

5. A seismic array according to claim 4 further comprising at least one third camera mounted on the platform facing sideways for capturing an image of at least one other platform in its field of view.

6. A seismic array according to claim 1, further comprising at least one hydrophone mount on at least one of the platforms.

7. A seismic array according to claim 1 further comprising at least one high contrast target on the buoys, platforms and/or guns.

8. A seismic array according to claim 7 further comprising at least two high contrast targets on at least one of the buoys, guns and platforms, so that the apparent distance between the high contrast targets in an image can be used to estimate the distance to the high contrast targets.

9. A method of calculating positions of elements of a seismic array comprising a plurality of buoys for floating on water, a plurality of platforms, each platform being attached to a respective buoy by a line; and a plurality of airguns, each being attached to a respective platform by a line, the method comprising:
capturing an image of the buoy with a camera mounted on a platform;
measuring the tilt and the roll of the platform;
identifying the position of the buoy in the image; and
calculating the relative position of the platform from the identified position of the buoy in the image, the measured tilt, and the measured roll.

10. A method according to claim 9, further comprising:
capturing an image of the airgun with a camera mounted on a platform;
identifying the position of the gun in the image; and
calculating the relative position of the airgun from the identified position of the airgun in the image, the measured tilt, the measured roll, and the calculated relative position of the platform.

11. A method according to claim 10, further comprising:
measuring the absolute position of the buoy with a gps system, and calculating the absolute position of the platform and the airgun from the absolute position of the buoy, the relative position of the platform and the relative position of the airgun.

12. A method according to claim 9, comprising:
for each of a plurality of platforms in a network, each attached to a respective buoy, capturing images of respective neighbouring platforms, and identifying the position of the neighbouring platform in the image;
calculating vectors representing the distance and direction to each of the respective neighbouring platforms from the identified positions of the neighbouring platforms, the tilt, and the roll; and
calculating the relative location of the each platform in the network using the vectors calculated from the images captured by the plurality of platforms.

13. A method according to claim 12, comprising calculating an ellipsoid indicating the relative location of each platform with a predetermined confidence level from the vectors.

14. A method according to claim 9, wherein identifying the position of an object, the object being a platform, buoy, or airgun, is carried out by:
calculating the correlation of the image with a reference image of the object in a known position for a plurality of offsets of the reference image;
determining the offset with the highest correlation; and
outputting the identified position of the object in the image from the determined offset.

15. A method according to claim 9, further comprising:
calculating the distance to an object, the object being a platform, buoy, or airgun, by:
identifying two locations on the object in the image of the object, the two locations being a known distance apart;
determining the distance in the image between the two locations; and
calculating the distance to the object from the distance in the image and the known distance between the locations.
